(19) United States
(12) Patent Application Publication
(10) Pub. No.: US 2010/0106411 A1
(43) Pub. Date: Apr. 29, 2010

(54) METHOD, APPARATUS AND COMPUTER PROGRAM PRODUCT FOR PROVIDING SEARCH RESULT AUGMENTATION

(76) Inventors: Mikko Nirhamo, Berlin (DE); Antje Friedrich, Berlin (DE); Charl Mocke, Berlin (DE)

Correspondence Address: DITTHAVONG MORI & STEINER, P.C., 918 Prince Street, Alexandria, VA, 22314, US

(21) Appl. No.: 12/257,843

(22) Filed: Oct. 24, 2008

(51) Int. Cl. G01C 21/36

(52) U.S. Cl. 701/209; 701/200

(57) ABSTRACT

A method for providing augmented search results may include receiving an indication of one or more potential destinations provided in response to a search operation, generating directional information indicative of a direction from a predefined location to a potential destination, and providing for display of the directional information along with a search result associated with the potential destination. An apparatus and computer program product corresponding to the method are also provided.

### TECHNOLOGICAL FIELD

Embodiments of the present invention relate generally to information service technology and, more particularly, relate to a method, apparatus and computer program product for providing augmentation to search results.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to the provision of services to users of electronic devices. Given the popularity of the Internet, and the vast sources of information that are accessible using the Internet, various Internet services have evolved to provide users with information from a plurality of different sources. In this regard, for example, Internet services have evolved for use with personal computers (PCs), mobile computers and other electronic devices in order to provide such devices with a vast array of services to enable access to information.

The information a particular user may desire to access can be obtained in a number of ways. As an example, users may search for the information they desire by providing a search term or query to a search engine. A search may then be conducted over documents, files or other content items accessible via a network, such as the Internet, based on the search term provided. However, the results of the search may not be presented in a desirable manner. In this regard, for example, results may be provided based on a number of different criteria and not all of the criteria may be of interest to the user.

Accordingly, it may be desirable to provide an improved mechanism for augmenting search results.

### BRIEF SUMMARY OF SOME EXAMPLES OF THE INVENTION

A method, apparatus and computer program product are therefore provided enable the provision of a mechanism for augmenting search results. In some exemplary embodiments, an indication of direction to a location provided as a result of a search may be provided. As such, some exemplary embodiments of the invention may provide for an improved capability for users to consider, for search results corresponding to one or a plurality of locations, which location to select, for example, to receive route guidance to the selected location.

In an exemplary embodiment, a method of providing augmented search results is provided. The method may include receiving an indication of one or more potential destinations provided in response to a search operation, generating directional information indicative of a direction from a predefined location to a potential destination, and providing for display of the directional information along with a search result associated with the potential destination.

In another exemplary embodiment, a computer program product for providing augmented search results is provided. The computer program product includes at least one computer-readable storage medium having computer-executable program code instructions stored therein. The computer-executable program code instructions may include program code instructions for receiving an indication of one or more potential destinations provided in response to a search operation, generating directional information indicative of a direction from a predefined location to a potential destination, and providing for display of the directional information along with a search result associated with the potential destination.

In another exemplary embodiment, an apparatus for providing augmented search results is provided. The apparatus may include a processor. The processor may be configured to receive an indication of one or more potential destinations provided in response to a search operation, generate directional information indicative of a direction from a predefined location to a potential destination, and provide for display of the directional information along with a search result associated with the potential destination.

In yet another exemplary embodiment, an apparatus for providing augmented search results is provided. The apparatus may include means for receiving an indication of one or more potential destinations provided in response to a search operation, means for generating directional information indicative of a direction from a predefined location to a potential destination, and means for providing for display of the directional information along with a search result associated with the potential destination.

Embodiments of the invention may provide a method, apparatus and computer program product for employment, for example, in mobile environments. As a result, for example, mobile device users may enjoy an improved capability for obtaining search results and/or guidance services via their respective computing devices.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a block diagram of a mobile terminal according to an exemplary embodiment of the present invention;

FIG. 3 illustrates a schematic block diagram of an apparatus for providing search result augmentation according to an exemplary embodiment of the present invention;

FIG. 4 illustrates a map view for a mapping service according to an exemplary embodiment of the present invention;

FIG. 5 illustrates an exemplary user interface for initiating a search according to an exemplary embodiment of the present invention;

FIG. 6 illustrates an example of augmented search results according to an exemplary embodiment of the present invention; and

FIG. 7 is a flowchart according to an exemplary method for providing search result augmentation according to an exemplary embodiment of the present invention.

### DETAILED DESCRIPTION OF SOME EMBODIMENTS OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Given the ubiquitous nature of mobile terminals, such as mobile phones and numerous other mobile electronic devices, communication networks are being employed more commonly for sharing and/or accessing information or services. Embodiments of the present invention may be employed in the context of augmenting search results. In this regard, for example, some embodiments of the present invention may provide an indication of direction relative to a user's current position for each result of a search conducted in the context of mapping or routing services. As such, search results may be provided with additional information beyond just an identification of a search result location and perhaps the distance to the location. Accordingly, a user's experience, and the utility of the results, may be enriched.

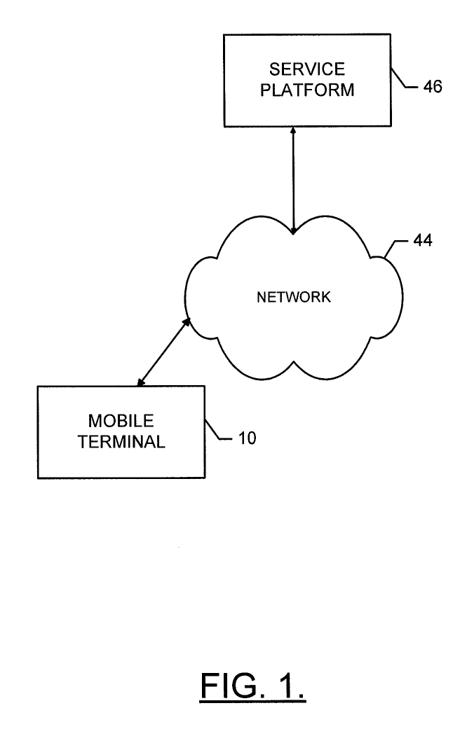

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) capable of communication with other devices via a network 44. In some cases, embodiments of the present invention may further include one or more additional communication devices and one or more network devices such as a service platform 46 with which the mobile terminal 10 may communicate to provide, request and/or receive information. In some embodiments, either or both of the mobile terminal 10 and the service platform 46 may include an apparatus 50 that may be configured to employ embodiments of the present invention. In this regard, it should be noted that the apparatus 50, which will be described in greater detail below, may be separately embodied at either one of the mobile terminal 10 or service platform 46 or at both of the mobile terminal 10 and the service platform 46 entirely or in a distributed manner. In an exemplary embodiment, if an instance of the apparatus 50 is embodied at both the mobile terminal 10 and the service platform 46, the apparatus 50 embodied at the mobile terminal 10 may comprise or execute a client application according to an exemplary embodiment, while the apparatus 50 embodied at the service platform 46 may include or comprise a server application according to an exemplary embodiment.

While several embodiments of the mobile terminal 10 may be illustrated and hereinafter described for purposes of example, other types of mobile terminals, such as portable digital assistants (PDAs), pagers, mobile televisions, mobile telephones, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

The network 44 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 44. Although not necessary, in some embodiments, the network 44 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 may be in communication with each other via the network 44 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 via the network 44. By directly or indirectly connecting the mobile terminal 10 and other devices to the network 44, the mobile terminal 10 may be enabled to communicate with the other devices, for example, according to numerous communication protocols including Hypertext Transfer Protocol (HTTP) and/or the like, to thereby carry out various communication or other functions of the mobile terminal 10.

Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with the network 44 and other devices by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 46 may be a device or node such as a server or other processing element. The service platform 46 may have any number of functions or associations with various services. As such, for example, the service platform 46 may be a platform such as a dedicated server (or server bank) associated with a particular information source or service (e.g., a search service and/or a mapping service), or the service platform 46 may be a backend server associated with one or more other functions or services. As such, the service platform 46 may represent a plurality of different services or information sources. The functionality of the service platform 46 may be provided by hardware and/or software components configured to operate in accordance with known techniques for the provision of information to users of communication devices. However, some of the functionality provided by the service platform 46 may be information provided in accordance with embodiments of the present invention.

In an exemplary embodiment, the service platform 46 may represent a source for information associated with a service that may be provided to the mobile terminal 10 in accordance with embodiments of the present invention. As such, for example, the mobile terminal 10 may run a client application configured to communicate with a corresponding server function at the service platform 46. The client application may be configured to enable entry of search criteria by a user of the mobile terminal 10, while the server function may enable the processing of the search criteria to provide search results. The search results may then be returned to the mobile terminal 10 for display. Augmentation to the search results may be performed either at the mobile terminal 10 or at the service platform 46.

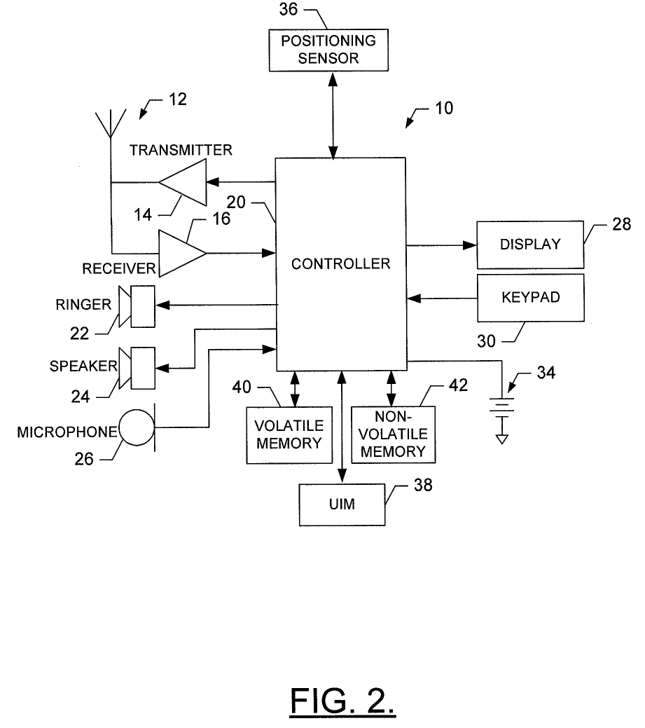

FIG. 2 illustrates a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention.

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

The controller 20 may include circuitry implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 may be allocated between these devices according to their respective capabilities. The controller 20 may also support other functionality for use in encoding, receiving and/or transmitting messages. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 may further include a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. In addition to the UIM 38, the mobile terminal 10 may be equipped with memory. For example, the mobile terminal 10 may include volatile memory 40 and/or non-volatile memory 42.

In some cases, the mobile terminal 10 may further include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 may include a pedometer or inertial sensor. In this regard, the positioning sensor 36 may be capable of determining a location of the mobile terminal 10, such as, for example, longitudinal and latitudinal directions of the mobile terminal 10, or a position relative to a reference point such as a destination or start point. In some cases, the positioning sensor 36 may include components enabling a determination of mobile terminal 10 position based on triangulation with respect to signals received from various sources or other techniques. Information from the positioning sensor 36 may then, in some cases, be communicated to a memory of the mobile terminal 10 or to another memory device to be stored as a position history or location information.

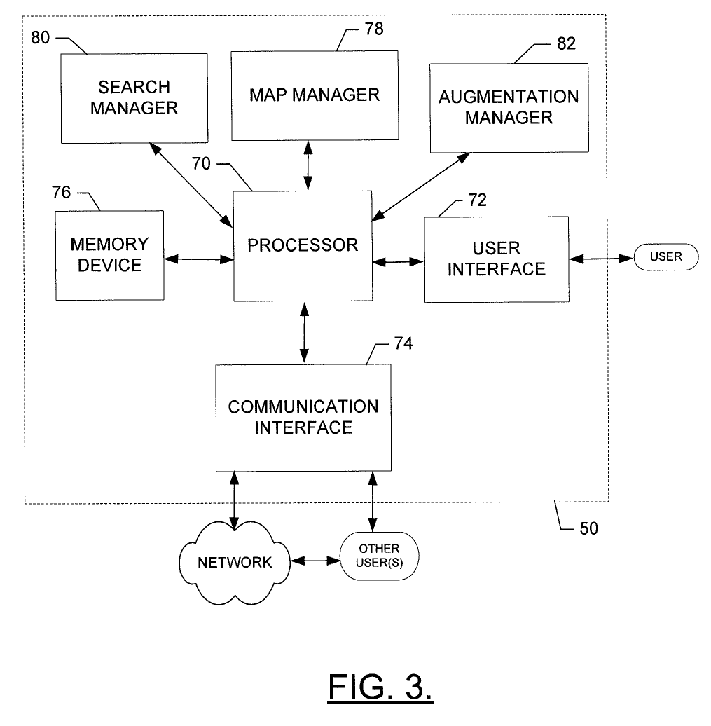

FIG. 3 illustrates a schematic block diagram of an apparatus for enabling the provision of augmented search results according to an exemplary embodiment of the present invention. An exemplary embodiment of the invention will now be described with reference to FIG. 3, in which certain elements of an apparatus 50 for providing augmented search results are displayed. As indicated above, the apparatus 50 of FIG. 3 may be employed, for example, on the service platform 46 or on the mobile terminal 10. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the service platform 46 or the mobile terminal 10), by a plurality of devices in a distributed fashion (e.g., split between the service platform 46 and the mobile terminal 10) or by devices in a client/server relationship (e.g., the mobile terminal 10 and the service platform 46). Furthermore, it should be noted that the devices or elements described below may not be mandatory and thus some may be omitted in certain embodiments. Additional elements could also be added.

Referring now to FIG. 2, an apparatus for providing augmented search results is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information (e.g., maps, information about various locations, services, businesses, etc., and/or the like) and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied at a communication device (e.g., the mobile terminal 10), the user interface 72 may include, among other devices or elements, any or all of a speaker, a microphone, a display, and a keyboard or the like.

In an exemplary embodiment, the processor 70 may be embodied as, include or otherwise control a map manager 78, a search manager 80 and an augmentation manager 82. As such, the map manager 78, the search manager 80 and the augmentation manager 82 may in some cases each be separate devices, modules, or functional elements. However, in other embodiments, some or all of the map manager 78, the search manager 80 and the augmentation manager 82 may be embodied within a single device, module, or functional element, such as the processor 70. The map manager 78, the search manager 80 and the augmentation manager 82 may each be any means such as a device or circuitry embodied in hardware, software or a combination of hardware and software (e.g., processor 70 operating under software control) that is configured to perform the corresponding functions of the map manager 78, the search manager 80 and the augmentation manager 82, respectively, as described below. In some embodiments, communication between any or all of the map manager 78, the search manager 80 and the augmentation manager 82 may be conducted via the processor 70. However, some or all of the map manager 78, the search manager 80 and the augmentation manager 82 may alternatively be in direct communication with each other.

In an exemplary embodiment, the map manager 78 and the search manger 80 may include instructions, code, modules, applications and/or circuitry for providing a mapping service and a search service, respectively. However, it should be noted that code, circuitry and/or instructions associated with the map manager 78 and/or the search manager 80 need not necessarily be modular.

The map manager 78 may be configured to generate and/or display a map of a particular area. Moreover, the map displayed may include landmarks, roads, buildings, points of interest, service points or numerous other geographical features. The map manager 78 may be further configured to include routing services. For example, the map manager 78 may be configured to determine one or more candidate routes between a current or starting location and a destination based on any known route determination methods. As such, for example, the map manager 78 may provide route guidance to a particular service point, landmark, building, point of interest, etc. In this regard, the map manager 78 may include an application or algorithm for determining possible routes such as, for example, Mapquest or other known route determination applications. Accordingly, the map manager 78 may be configured to determine candidate routes using operational information such as driving time, driving distance, fuel consumption, battery consumption, etc. The map manager 78 may incorporate into the map display various ones of the geographical features and other supplemental information about a particular service point. For example, the map manager 78 may display an icon or another identifier that is indicative of the availability of a particular product or service (e.g., gasoline or food) in association with the particular service point (e.g., a gas station or restaurant).

In an exemplary embodiment, the search manager 80 may include a search engine configured to receive a query or search term identification and search various accessible sources (e.g., databases such as may be included in the memory device 76 or accessible via the network 44) for information associated with the query or search term identification. When embodied at the mobile terminal, the search manager 80 may also be configured to enable entry of the information including search or query terms and display of results of the search. The information may be, for example, static and/or dynamic attributes associated with the query. As such, according to an exemplary embodiment, in response to a search associated with a service point (e.g., a search for the title or name of the service point or a search associated with an event or service provided at the service point), the search manager 80 may be configured to provide a listing of search results that may have an association with the query.

In an exemplary embodiment, the search manager 80 and the map manager 78 may be operated in combination to provide directory or look-up services related to a particular service point. As such, for example, a search for a nightclub may result in a listing of nightclubs (e.g., a service point for nighttime entertainment, drinks and/or dancing) and a search for a gas station may result in a listing of gas stations being provided to the user requesting the directory or look-up service (e.g., at the mobile terminal 10). Furthermore, if any of the nightclubs, gas stations, or other objects of the search happen to fall within an area of a map currently being displayed at the mobile terminal 10 by the map manager 78, the corresponding objects of the search may be indicated on the map (e.g., with a star, icon, dot or some other distinguishing feature). Alternatively or additionally, a listing of search results may be provided by the search manager 80 independent of any view of the map and the map view may be provided in response to selection of one of the search results as an object (or potential object) for guidance services to the selected search result location. Either along with the listing of search results or in response to selection or highlighting of a particular search result, more detailed information about the corresponding service point, location, business, landmark or the like, may be presented by the search manager 80. The detailed information may include street address, phone number, email address, business name, building name, services or products offered, hours of operation, and/or many other pieces of information. If desired, the user may then decide to visit one of the search result locations and select the location or a guidance option to receive route guidance thereto.

The augmentation manager 82 may be configured to augment the search results by providing directional information in association with one or more of the search results. In an exemplary embodiment, the augmentation manager 82 may be configured to provide direction information for each search result provided. In some cases, the directional information may provide an indication of the direction of the corresponding search result from the user's current location. As such, for example, an arrow, directional descriptor (e.g., NW for North-West, S for South, ESE for East-South-East, etc.), or other indicator of directional information may be provided along with the search results. In order to generate the directional information, the augmentation manager 82 may be configured to receive information regarding current device location (e.g., location of the mobile terminal 10 as indicated by the positioning sensor 36) and the geographic location of each search result provided. The augmentation manager 82 may be configured to compare the current device location to the geographic location of a particular search result in order to determine a direction of travel or map direction from the current device location to the geographic location of the particular search result. The arrow or directional descriptor may then by selected or generated based on the determined direction of travel or map direction.

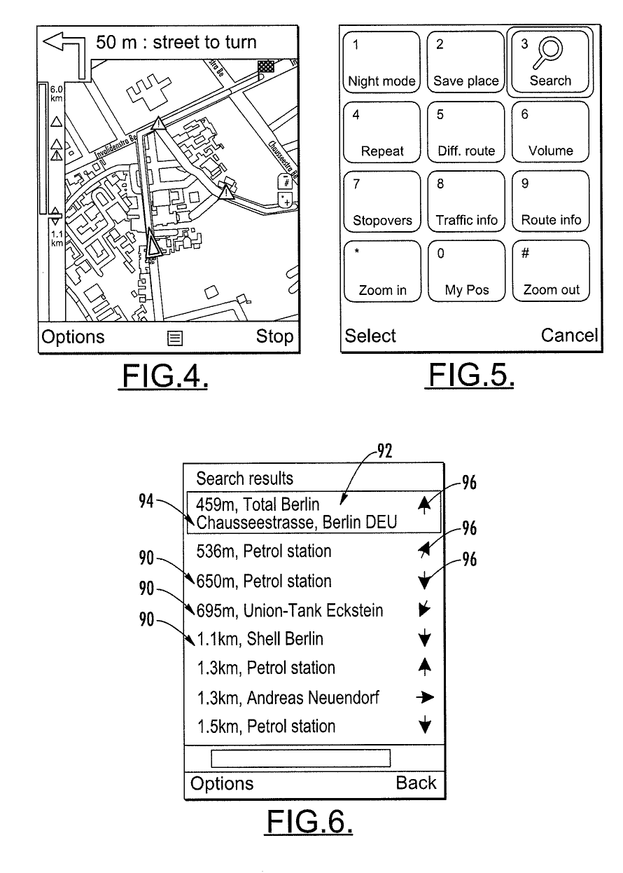

FIG. 4 shows an exemplary display screen that may be produced by the map manager 78 showing an example of a map and a guidance route. The “Options” menu of FIG. 4 may be selected to access various functions or services that may be performed with respect to the map presented by the map manager 78. One of the available options that may be offered in response to selection of the “Options” menu of FIG. 4 may be a “Search” option. However, other mechanisms for accessing the search option may also be provided in alternative embodiments. In this regard, continuing with the example above, FIG. 5 shows one example of an option for implementing a searching function of the search manager 80. In this regard, as shown in FIG. 5, each of several soft keys may have a corresponding function and one key (e.g., the number 3 key) may be associated with a search function. Thus, for example, selection of the “Options” menu of FIG. 4 may result in the provision of the option keys shown in FIG. 5.

In an exemplary embodiment, after selection of the key associated with the search function (e.g., the number 3 key), the search manager 80 may be invoked and the user may enter in a keyword or other query (e.g., gas station). In response to initiation of the search, the search manager 80 may utilize searching techniques to identify search results that correspond to the query (e.g., gas stations). In some cases, the query may include search parameters that may be employed to limit the search. For example, a distance parameter may limit search results to only those results that correspond to the query, but are within the distance defined by the distance parameter (e.g., 10 miles). Other search parameters may include, for example, limitations on the number of search results displayed, instructions to provide results in alphabetical order, distance order or according to some other ordering scheme. Alternatively or additionally, settings or preferences associated with the user may provide guidance to the search manager 80 with respect to conducting and/or displaying results of the search. Filtering criteria may also be applied.

FIG. 6 shows an exemplary display of a listing of search results. As can be seen from FIG. 6, according to this example, each entry 90 is listed on a separate line with a corresponding distance from the current location of the user to the corresponding potential or candidate destination associated with each entry 90. The entries are ordered within the listing based on distance from the current location of the user (e.g., the user of the mobile terminal 10). A highlighted entry 92 may be expanded to show detailed information 94, which may be a street address or other information specific to the highlighted entry 92. Each entry 90 may also include directional information 96, which in this example is provided in the form of a directional arrow. The directional information 96 may be oriented with respect to the current location on the map view generated by the map manager 78. As such, for example, if the map view (e.g., shown in FIG. 4) is oriented with North-up so that North is always oriented toward the top of the display, then the directional information 96 may be generated and/or displayed with the same North-up orientation. Thus, as an example, an entry corresponding to a service point located to the North may be accompanied by an arrow pointing substantially straight up or to the top of the list, while an entry associated with a service point located to the South may be accompanied by an arrow pointing substantially straight down or to the bottom of the list. As an alternative to North-up display, a head up (e.g., where the current heading of the user is displayed oriented toward the top of the display), or any other display orientation may be provided on the map view. Thus, for example, if an entry corresponds to a service point located to the North while the map view is in a head up display mode and the user is currently heading south, the arrow may point substantially straight down or to the bottom of the list. Thus, when a particular display orientation is selected, the directional information 96 may be oriented based on the display orientation.

In an exemplary embodiment, the reference point from which the directional information 96 is based may not change, even as the user transits a route to a particular location or otherwise changes location. As such, the arrow may not change directions after the search results are provided in some embodiments. However, in some alternative embodiments, the reference point from which the directional information 96 is based may change to correspond to the user's current location and/or heading. As such, for example, directional information 96 could be altered based on device heading. In this regard, device orientation may be determined (e.g., via a compass or movement sensors) and when rotating the device, the directional information (and in some cases also the map in the background of the display (e.g., if the display is large enough to display results and map information simultaneously)) may be changed accordingly. Thus, for example, the arrows indicating direction may indicate direction to the search results, which may update automatically even if the user is rotating the device. Accordingly, for example, if a user is shifting to orient himself or herself to have a desired search result directly in front of them, the user may rotate until the desired search result's directional information points straight ahead.

As an alternative, the directional information 96 may be provided with reference to some selected location chosen by the initiator of the search. For example, the directional information 96 could be provided with reference to the direction from some selected location on a map that may be chosen by the user. Thus, the user may indicate a reference location and the search results may provide directional information 96 indicative of the direction from the reference location to each corresponding one of the search results. Accordingly, embodiments of the present invention may provide for directional information 96 to be provided indicating a direction from some predefined location (e.g., the current location of the user, the initial location of the user, or some location selected by the user) to the location of one or more respective search results. According to one exemplary embodiment the user may also alternate the reference location after the search has been made, in order to see the directional information 96 indicating directions from the selected location or the current location, for example.

Users of embodiments of the present invention may find directional information useful in that, the closest point of interest or service point may not actually be in a convenient or desirable direction for the user to travel. For example, if the user is visiting the downtown area of a city and has finished touring, the user may wish to return to his or her hotel located South of the city. However, the user may wish to get gas on the way back to the hotel. Using embodiments of the present invention, the user may be enabled to recognize which of the available search result entries is actually in the desired direction of travel. Thus, the closest gas station, which may be to the North (assume a North up display mode for FIG. 6), may be avoided since the closest gas station is, although closer than other stations, in the wrong direction based on the user's current position and desired direction of travel. Accordingly, the user can also deduce, not only the closest gas station in the correct direction of travel, but potentially also the number of gas stations from which the user could select on the way back to the hotel.

Embodiments of the present invention may also be employed in contexts other than vehicular navigation. For example, some embodiments may be employed in the context of pedestrian navigation. In this regard, providing an indication of the direction to search results may enable users to avoid an extra walk in a direction that does not correspond to the desired direction of travel.

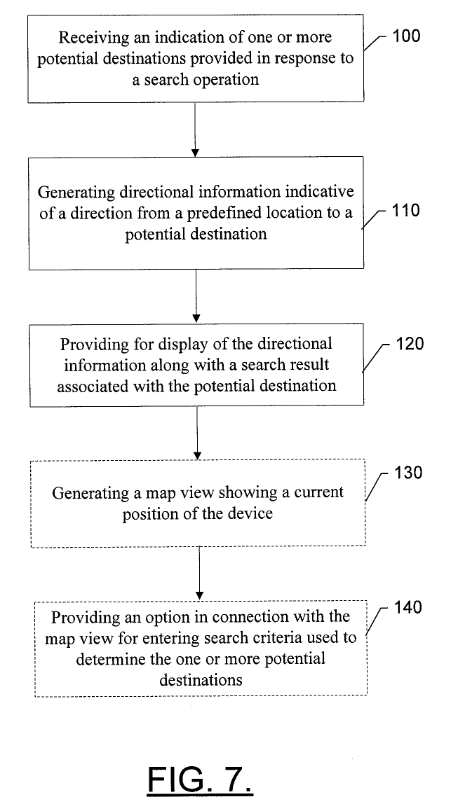

FIG. 7 is a flowchart of a system, method and program product according to some exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, service platform or other apparatus employing embodiments of the present invention and executed by a processor in the mobile terminal, service platform or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing search result augmentation as illustrated, for example, in FIG. 7 may include receiving an indication of one or more potential destinations provided in response to a search operation at operation 100, generating directional information indicative of a direction from a predefined location (e.g., from a current location of a device initiating the search operation, from a location where the search operation is initiated and/or from a location selected by the device initiating the search operation) to a potential destination at operation 110, and providing for display of the directional information along with a search result associated with the potential destination at operation 120.

In some embodiments, the method may include further optional operations, an example of which is shown in dashed lines in FIG. 7. Optional operations may be performed in any order and/or in combination with each other in various alternative embodiments. As such, the method may further include operations of generating a map view showing a current position of the device at operation 130 and providing an option in connection with the map view for entering search criteria used to determine the one or more potential destinations at operation 140.

In some embodiments, certain ones of the operations above may be modified or further amplified as described below. It should be appreciated that each of the modifications or amplifications below may be included with the operations above either alone or in combination with any others among the features described herein. In this regard, for example, receiving the indication in operation 100 may include receiving a listing of search results corresponding to each of the potential destinations. In some cases, providing for display of the directional information may include providing for display of each of the search results with corresponding directional information specific to each of the search results. Alternatively or additionally, generating the directional information may include generating an arrow pointing toward the potential destination from an origin corresponding to a position of the device. In some embodiments, generating the directional information may include generating an arrow oriented in the same orientation that a map view showing a current position of the device is oriented. In an exemplary embodiment, providing for display of the directional information may include providing for continued display of the directional information oriented relative to an original position of the device regardless of subsequent motion of the device.

In an exemplary embodiment, an apparatus for performing the method of FIG. 7 above may comprise a processor (e.g., the processor 70) configured to perform some or each of the operations (100-140) described above. The processor may, for example, be configured to perform the operations (100-140) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-140 may comprise, for example, the processor 70, respective ones of the map manager 78, the search manager 80 and the augmentation manager 82, or an algorithm executed by the processor for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of one or more potential destinations provided in response to a search operation;
generating directional information indicative of a direction from a predefined location to a potential destination; and
providing for display of the directional information along with a search result associated with the potential destination.

2. The method of claim 1, wherein receiving the indication comprises receiving a listing of search results corresponding to each of the potential destinations.

3. The method of claim 2, wherein providing for display of the directional information comprises providing for display of each of the search results with corresponding directional information specific to each of the search results.

4. The method of claim 1, wherein generating the directional information comprises generating an arrow pointing toward the potential destination from an origin corresponding to a position of a device initiating the search operation.

5. The method of claim 4, wherein generating the directional information comprises generating an arrow oriented in the same orientation that a map view showing a current position of the device is oriented.

6. The method of claim 1, further comprising generating a map view showing a current position of a device initiating the search operation and providing an option in connection with the map view for entering search criteria used to determine the one or more potential destinations.

7. The method of claim 1, wherein providing for display of the directional information comprises providing for continued display of the directional information oriented relative to an original position of a device initiating the search operation regardless of subsequent motion of the device.

8. The method of claim 1, wherein generating the directional information comprises generating an arrow pointing toward the potential destination from a location selected by a device initiating the search operation.

9. A computer program product comprising at least one computer-readable storage medium having computer-executable program code instructions stored therein, the computer-executable program code instruction comprising:
program code instructions for receiving an indication of one or more potential destinations provided in response to a search operation;
program code instructions for generating directional information indicative of a direction from a predefined location to a potential destination; and
program code instructions for providing for display of the directional information along with a search result associated with the potential destination.

10. The computer program product of claim 9, wherein program code instructions for receiving the indication include instructions for receiving a listing of search results corresponding to each of the potential destinations.

11. The computer program product of claim 10, wherein program code instructions for providing for display of the directional information include instructions for providing for display of each of the search results with corresponding directional information specific to each of the search results.

12. The computer program product of claim 9, wherein program code instructions for generating the directional information include instructions for generating an arrow pointing toward the potential destination from an origin corresponding to a position of a device initiating the search operation.

13. The computer program product of claim 12, wherein program code instructions for generating the directional information include instructions for generating an arrow oriented in the same orientation that a map view showing a current position of the device is oriented.

14. The computer program product of claim 9, further comprising program code instructions for generating a map view showing a current position of a device initiating the search operation and providing an option in connection with the map view for entering search criteria used to determine the one or more potential destinations.

15. The computer program product of claim 9, wherein program code instructions for providing for display of the directional information include instructions for providing for continued display of the directional information oriented relative to an original position of a device initiating the search operation regardless of subsequent motion of the device.

16. The computer program product of claim 9, wherein program code instructions for generating the directional information include instructions for generating an arrow pointing toward the potential destination from a location selected by a device initiating the search operation.

17. An apparatus comprising a processor configured to:
receive an indication of one or more potential destinations provided in response to a search operation;
generate directional information indicative of a direction from a predefined location to a potential destination; and
provide for display of the directional information along with a search result associated with the potential destination.

18. The apparatus of claim 17, wherein the processor is configured to receive the indication by receiving a listing of search results corresponding to each of the potential destinations.

19. The apparatus of claim 18, wherein the processor is configured to provide for display of the directional information by providing for display of each of the search results with corresponding directional information specific to each of the search results.

20. The apparatus of claim 17, wherein the processor is configured to generate the directional information by generating an arrow pointing toward the potential destination from an origin corresponding to a position of a device initiating the search operation.

21. The apparatus of claim 20, wherein the processor is configured to generate the directional information by generating an arrow oriented in the same orientation that a map view showing a current position of the device is oriented.

22. The apparatus of claim 17, wherein the processor is further configured to generate a map view showing a current position of a device initiating the search operation and providing an option in connection with the map view for entering search criteria used to determine the one or more potential destinations.

23. The apparatus of claim 17, wherein the processor is configured to provide for display of the directional information by providing for continued display of the directional information oriented relative to an original position of the device regardless of subsequent motion of a device initiating the search operation.

24. The apparatus of claim 17, wherein the processor is configured to generate the directional information by generating an arrow pointing toward the potential destination from a location selected by a device initiating the search operation.

25. An apparatus comprising:
means for receiving an indication of one or more potential destinations provided in response to a search operation;
means for generating directional information indicative of a direction from a predefined location to a potential destination; and
means for providing for display of the directional information along with a search result associated with the potential destination.

26. The apparatus of claim 25, wherein means for generating the directional information comprises means for generating an arrow pointing toward the potential destination from an origin corresponding to a position of a device initiating the search operation.
